(19) United States
(12) Patent Application Publication
(10) Pub. No.: US 2003/0017853 A1
(43) Pub. Date: Jan. 23, 2003

(54) Method and apparatus for enhancing the data transmission capacity of a wireless communication system

(75) Inventors: Sridhar Kanamaluru, West Windsor, NJ (US); Zygmond Turski, Florence, NJ (US); Henry Owen, Medford, NJ (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(73) Assignee: SARNOFF CORPORATION

(21) Appl. No.: 10/194,984

(22) Filed: Jul. 12, 2002

Related U.S. Application Data
(60) Provisional application No. 60/305,240, filed on Jul. 13, 2001.
(60) Provisional application No. 60/305,249, filed on Jul. 12, 2001.

(51) Int. Cl. H04B 1/38; H04Q 7/20

(52) U.S. Cl. 455/562; 455/561

(57) ABSTRACT

A method and apparatus for enhancing the data transmission capacity of a wireless communication system includes a smart antenna array for forming a radiation pattern to communicate with a plurality of mobile devices and control circuitry for adaptively modifying the radiation pattern to increase the carrier-to-interference (C/I) ratio of the wireless communication system.

### CROSS-REFERENCE TO RELATED APPLICATIONS

This application claims benefit of U.S. provisional patent application serial No. 60/305,240, filed Jul. 13, 2001, which is herein incorporated by reference.

### BACKGROUND OF THE INVENTION

1. Field of the Invention

The present invention generally relates to wireless communication systems and, more particularly, to a method and apparatus for enhancing the data transmission capacity of a wireless communication system.

2. Description of the Related Art

In general, wireless communication systems use hexagon-shaped cells to divide a given geographical area to a more manageable size, given constraints such as carrier frequencies, base station power output, number of users, and local terrain. This approach is commonly known as a “cellular” approach and is applicable for cellular telephone and personal communications service (PCS) applications using the 800 MHz, 900 MHz, 1800 MHz, and 1900 MHz frequency bands. Each of the cells may, in turn, be sub-divided into sectors that are commonly (but not necessarily) 1200 wide along the azimuth.

The transmit and receive antennas used by the base stations in each cell are typically omni-directional for covering the entire cell, or have a beamwidth of 120° for covering an individual cell sector. Currently, the antenna gain and beam direction for each base station is fixed and cannot be varied dynamically. As such, base station antennas typically receive signals from users of other cell sites who occupy the same channel. This co-channel interference reduces the carrier-to-interference (C/I) ratio and, hence, the capacity of the system. In addition, other intentional or unintentional electromagnetic emissions in the same frequency band will give rise to signal interference. Due to co-channel interference, wireless communication systems often operate below their theoretical data transmission capacity and do not use the scarce frequency spectrum optimally.

Therefore, there is a need in the art for a method and apparatus that enhances the capacity of a wireless communication system.

### SUMMARY OF THE INVENTION

The present invention is a method and apparatus for enhancing the data transmission capacity of a wireless communication system. The wireless communication system comprises a base station in communication with a plurality of mobile devices over a respective plurality of channels. Each of the plurality of channels is defined in a frequency band by a particular identifying attribute. The present invention comprises an antenna array for forming a beam in the radiation pattern. For example, the antenna array can comprise a phased array. The present invention further comprises control circuitry for switching the direction of the beam towards a location or an incoming signal of each mobile device when each mobile device is communicating over a respective channel. In one embodiment, the location of each mobile device is determined by a location sensing unit that utilizes the particular identifying attribute for each mobile device to determine the direction of the strongest transmitted signal from each mobile device. In another embodiment, the location each mobile device is determined via a physical location of each mobile device received from the wireless communication system.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a cell of a wireless communication system in which the present invention can be employed;

FIG. 2 depicts a block diagram showing one embodiment of the smart antenna of the present invention as used in a time division multiple access (TDMA) wireless communication system;

FIG. 3 depicts a block diagram showing one embodiment of a phased array of the smart antenna of FIG. 2;

FIG. 4 depicts a block diagram showing one embodiment of a location sensing unit of the smart antenna of FIG. 2; and

FIG. 5 depicts a block diagram showing another embodiment of a smart antenna of the present invention as used in a code division multiple access (CDMA) wireless communication system.

### DETAILED DESCRIPTION

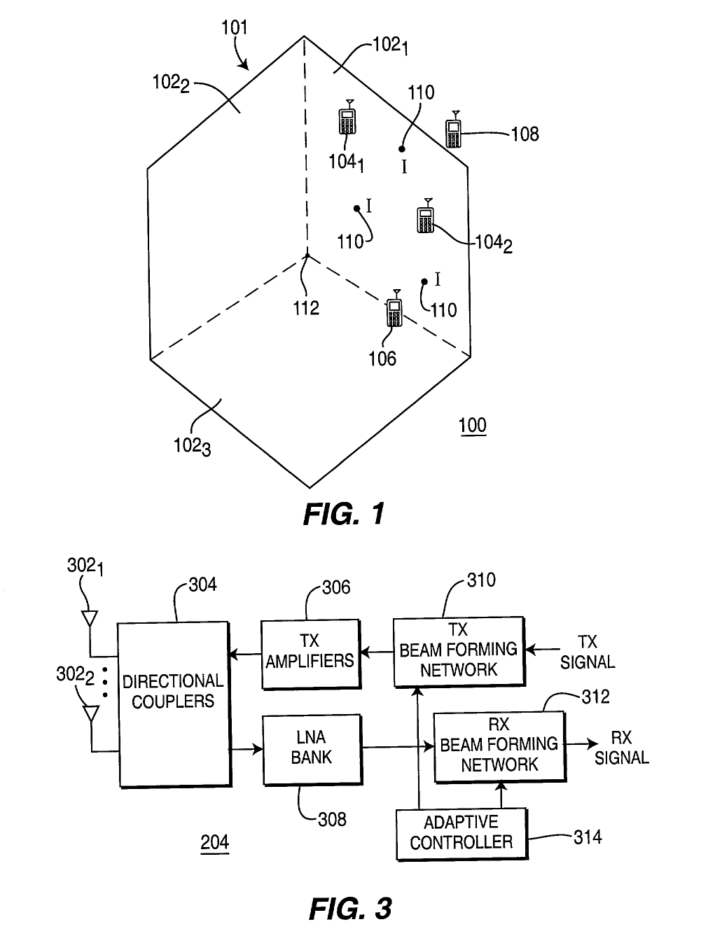

FIG. 1 depicts a cell 101 of a wireless communication system 100 in which the present invention can be employed. As shown, the cell 101 is divided into three sectors 102₁, 102₂, and 102₃. A base station 112 provides wireless communication service to mobile devices within the sector 102₁. In particular, mobile devices 104₁ and 104₂ are present within the sector 102₁ and are in communication with the base station 112. Interferers 110 are also present within the sector 102₁, which interfere with communication between the base station 112 and the mobile devices 104₁ and 104₂. Mobile device 108 is present within an adjacent cell (not shown) and is not in communication with the base station 112. Likewise, mobile device 106 is in the sector 102₃ and is also not in communication with the base station 112. Mobile devices 106 and 108 can also interfere with communication between the base station 112 and the mobile devices 104₁ and 104₂. Interference from mobile devices 106 and 108 is known as co-channel interference. Interference from the interferers 110 as well as co-channel interference can reduce the C/I ratio and, consequently, reduce the available number of channels, and hence, the data transmission capacity of the wireless communication system 100. Those skilled in the art will appreciate that the cell 101 can be divided into any number of sectors or can remain undivided (i.e., the base station 112 serves the entire cell).

The C/I ratio of a received signal at the base station 112 depends on the gain of the antenna used and the location (distance and angle) of the mobile device. In accordance with the present invention, the C/I ratio for the wireless communication system 100 is improved by employing a smart antenna at the base station 112. As described below, the smart antennas of the present invention are used directly with the existing base stations (e.g, base station 112) of the wireless communication system 100, obviating the need for substantial modifications to the base stations.

As described more fully below, each mobile device communicates with the base station 112 over a channel defined in a frequency band by a particular identifying attribute. The present invention will first be described with reference to time division multiple access (TDMA) wireless communication systems, such as the Global System for Mobile Communications (GSM) or the IS-136 system, where the particular identifying attribute is a time slot. The present invention will then be described with reference to code division multiple access (CDMA) wireless communication systems, such as IS-95A and IS-95B systems, wideband CDMA (W-CDMA) systems, or CDMA2000© systems, where the particular identifying attribute is an orthogonal code.

To best explain the invention as it applies to TDMA wireless communication systems, it is useful to understand the operation of such systems. In TDMA systems, the total available frequency range for the service is sub-divided into frequency bands that are characterized by the channel carrier frequency and the bandwidth. For example, the GSM system has a total bandwidth of 25 MHz for the uplink (i.e., mobile device to the base station) and a total bandwidth of 25 MHz for the downlink (i.e., base station to the mobile device). Both the uplink and the downlink total bandwidths are divided into 125 frequency channels each having a 200 kHz bandwidth.

A “channel” in a TDMA system is defined in a particular frequency band by a particular time slot. Each mobile device is allotted a specific time slot in which the mobile device is allowed to transmit and receive traffic. As used herein, “traffic” means data or speech signals. The time slots can be separated by a guard period to account for lack of perfect synchronization at the mobile device due to its mobility. The maximum number of time slots supported in a given frequency band are grouped together as a frame. In the GSM system, for example, each frequency band supports 8 time slots for full-rate communication and 16 time slots for half-rate communication. For full-rate communication, there are 8 time slots per frame. Each time slot is spaced from the next by a 30.46 μs guard period.

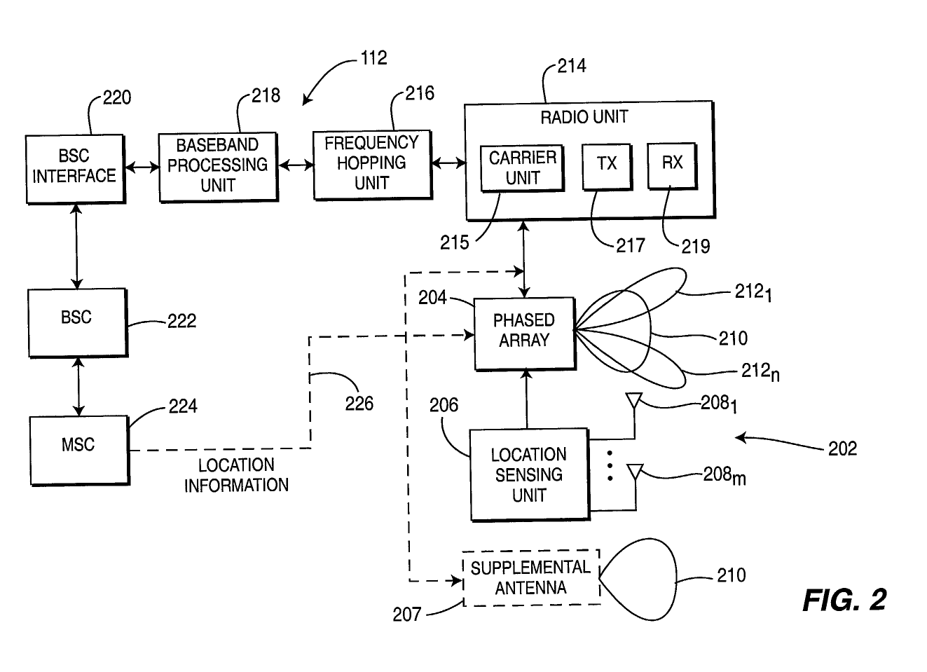

FIG. 2 depicts a block diagram showing one embodiment of the present invention as used in a TDMA wireless communication system. Although the present invention will be described with reference to a GSM wireless communication system, those skilled in the art will appreciate that the present invention can be used with any TDMA wireless communication system. The present invention comprises a smart antenna 202 coupled to the base station 112. The base station 112 is coupled to a base station controller (BSC) 222. The BSC 222 is coupled to a mobile switching center (MSC) 224 of the wireless communication system.

Briefly stated, the smart antenna 202 generates radiation patterns to transmit and/or receive traffic to and from the mobile devices within the service area of the base station (e.g., a sector of a cell). The base station 112 modulates and demodulates the traffic and performs other data processing functions under control of the BSC 222. The BSC 222 manages radio resources for a plurality of base stations, including base station 112, and facilitates hand-overs therebetween. The MSC 224 is typically coupled to the publicly switched telephone network (PTSN) and provides the functionality needed to handle the mobile devices, including registration, authentication, inter-MSC hand-overs, and the like.

More specifically, the-base station 112 illustratively comprises a radio unit 214, a frequency hopping unit 216, a baseband processing unit 218, and a BSC interface 220. The radio unit 214 comprises a carrier unit 215, a transmitter 217, and a receiver 219. The radio unit 214 is coupled to the frequency hopping unit 216, which implements a frequency hopping matrix in a well known manner. The frequency hopping unit 216 is coupled to the baseband processing unit 218, which forms TDMA frames, encodes and encrypts signals to be transmitted, and decodes and decrypts received signals. The baseband processing unit 218 is coupled to the BSC interface 220 for transmitting and receiving signals to and from the BSC 222. The BSC interface 220 can comprise, for example, a microwave link between the base station 112 and the BSC 222. Those skilled in the art will appreciate that the base station 112 can comprise additional and/or different components depending on the wireless communication system in use.

In accordance with one embodiment of the present invention, the smart antenna 202 comprises a phased array 204 and a location sensing unit 206. The phased array is a multi-beam, beam-switching antenna array capable of generating narrow, high-gain beams in its radiation patterns for transmission and/or reception of traffic to and/or from the mobile devices. Briefly stated, the phased array 204 dynamically changes its radiation pattern to direct beams towards individual mobile devices when the mobile devices are communicating with the base station 112 over their respective channels (i.e., during their respective time slots). The phased array 204 generates both transmit and receive beams for each frequency band in use by the particular base station 112. For a given frequency band, the beam is switched from one mobile device to the next for each time slot in use. The beams are switched towards the location of each mobile device for maximizing the C/I ratio for each mobile device. In the present embodiment, the location of each mobile device is defined as the direction of the strongest transmitted signal from each mobile device, which is determined by the location sensing unit 206.

FIG. 3 depicts a block diagram showing an illustrative embodiment of the phased array 204. As shown, the phased array 204 comprises a plurality of antenna elements 302₁ through 302ₖ (where k is an integer greater than 1), directional couplers 304, transmission amplifiers 306, a low-noise amplifier (LNA) bank 308, a transmission beamforming network 310, a reception beamforming network 312, and an adaptive controller 314. The antenna elements 302₁ through 302ₖ are arranged in an array and are coupled to the directional couplers 304. The directional couplers 304 couple transmission signals from the transmission amplifiers 306 to the antenna elements 302₁ through 302ₖ, and coupled received signals from the antenna elements 302₁ through 302ₖ to the LNA bank 308. The transmit beams are formed by the transmission beamforming network 310 under control of the adaptive controller 314. Likewise, the receive beams are formed by the reception beamforming network 312 also under control of the adaptive controller 314. The adaptive controller 314 controls the direction and gain of each beam formed by the beamforming networks 310 and 312 in a known manner.

In an alternative embodiment, the phased array 204 can comprise two separate antenna arrays, one for reception and one for transmission. In this embodiment, the directional couplers 304 are removed and the transmission amplifiers 306 and the LNA bank 308 are couple directly to the respective transmission and reception antenna arrays.

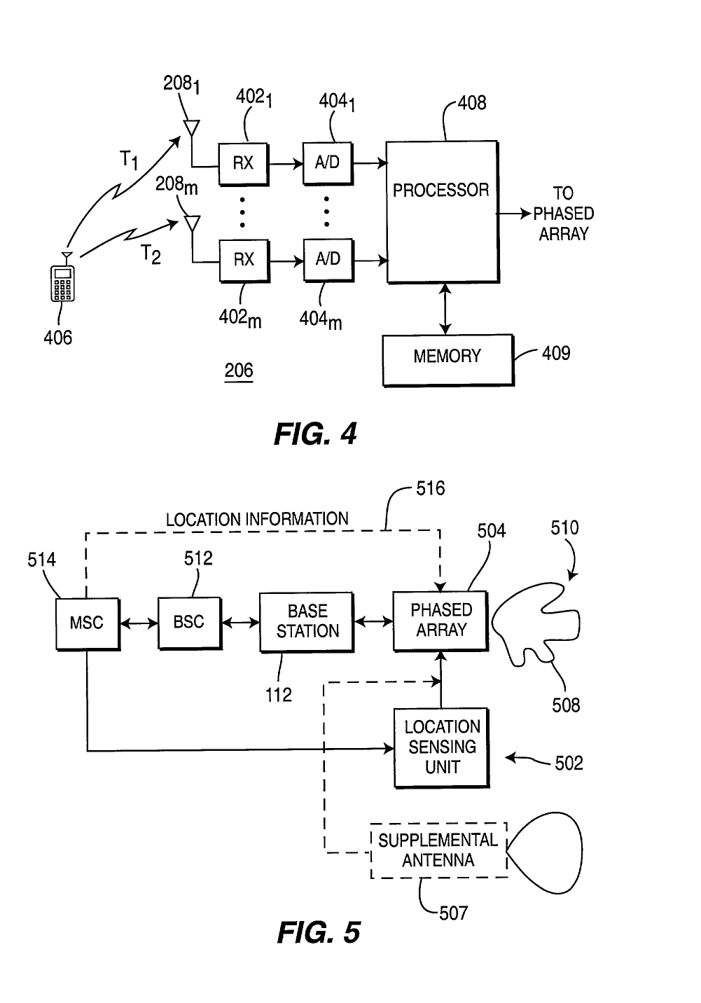

FIG. 4 depicts a block diagram showing an illustrative embodiment of the location sensing unit 206. The location sensing unit 206 utilizes the particular identifying attribute associated with each mobile device (i.e., a time slot in the present embodiment) to determine the direction of the strongest transmitted signal from each mobile device. The location sensing unit 206 comprises antenna elements ²⁰⁸₁ through 208ₘ (where m is an integer greater than 1), receivers 402₁ through 402ₘ, analog-to-digital (A/D) converters 404₁ through 404ₘ, a processor 408, and memory 409. The antenna elements 208₁ through 208ₘ are spatially separated to receive spatially diverse versions of an RF signal transmitted by a mobile device. In an alternative embodiment, the antenna elements 208₁ through 208ₘ are part of the array of antenna elements 302₁ through 302ₖ in the phased array 204. In either case, the antenna elements 208₁ through 208ₘ receive a transmitted signal from a mobile device 406 at different times T₁ and T₂ for a given location of the mobile device 406. The location sensing unit 206 determines which mobile device is transmitting by identifying the particular identifying attribute of the mobile device (i.e., the time slot assigned to the mobile device). This may involve the wireless communication system providing frequency and time slot information, or the determination of either or both of these parameters by the location sensing unit 206. By analyzing amplitude and phase characteristics of the received signals, the angle-of-arrival of the transmitted signal can be determined.

More specifically, the outputs of the antenna elements 208₁ through 208ₘ are coupled to receivers 402₁ through 402ₘ, respectively, for demodulation. The demodulated outputs from the receivers 402₁ through 402ₘ are digitized by analog-to-digital (A/D) converters 404₁ through 404ₘ, and are then coupled to the processor 408. The processor 408 executes an algorithm stored within the memory 409 to determine the angle-of-arrival and signal strength of the received signals from the mobile device 406 using the phase and amplitude relationship between the received signal paths. Given the angle-of-arrival and strength for each of the received signals, the processor 408 can determine the direction of the strongest transmitted signal from the mobile device 406 during a particular time slot. Such algorithms for determining the angle-of-arrival and received strength of RF signals are well-known in the art.

Returning to FIG. 2, in operation, the phased array 204 receives information from the location sensing unit 206 regarding the direction of the strongest transmitted signal in a particular time slot from a given mobile device (not necessarily the direct signal in multipath environments). Given the direction of the strongest transmitted signal for a mobile device in a particular time slot, the phased array 204 directs a beam in this direction when the mobile device is communicating with the base station during its time slot. The phased array 204 then switches the direction of the beam to communicate with the mobile device assigned to the next time slot, and so on. The beam is switched from one direction to another within the guard period between time slots (e.g., 30.46 μs in GSM systems) to remain in communication with each of the mobile devices in a given frequency band. Each time slot is of a short enough duration that the phased array 204 can transmit traffic to a mobile device via the path of the strongest received signal even if this path is not the direct path to the mobile device. For example, in a GSM system, each time slot has a 0.577 ms duration over which the present invention assumes an approximately static channel corresponding to the strongest received signal from the mobile device.

As described above, the phased array 204 is capable of forming many beams 212₁ through 212ₙ for communicating with the mobile devices over many frequency bands. The direction of each of the beams 212₁ through 212ₙ is switched as described above. Traffic received by the phased array 204 is coupled to the radio unit 214 of the base station 112. Likewise, traffic to be transmitted by the phased array 204 is received from the radio unit 214. In an alternative embodiment, the phased array 204 can direct only the receive beams to the mobile devices during their respective time slots, while the phased array 204 transmits signals to the mobile devices omni-directionally, or by sector.

In addition, the phased array 204 can also form a broad beam 210 for broadcasting signals (e.g., control messages, paging messages, and the like) to the mobile devices within the sector. The broad beam 210 can also be used to service mobile devices in an “idle” state (i.e., not transmitting or receiving traffic). In an alternative embodiment, the broad beam 210 for broadcasting signals is generated by a supplemental antenna 207, such as an omni-directional antenna.

In this manner, the smart antenna 202 of the present invention couples directly to the base station 112 and requires no changes to the architecture of the base station 112. This allows the present invention to be used with existing base stations in current TDMA wireless communication systems without substantial modification thereto.

In an alternative embodiment, the smart antenna 202 comprises only the phased array 204. The physical location of each mobile device is received from the MSC 224 via dashed path 226. The beams of the phased array 204 are switched towards the location of each mobile device. In the present embodiment, the location of each mobile device is defined as the physical location of each mobile device, which is received from the MSC 224 of the wireless communication system. In particular, the wireless communication system employing the present invention may be adapted to determine the physical location of each mobile device using, for example, the Global Positioning System (GPS). Given the physical location of each mobile device, the present invention can determine the required beam direction for each mobile device. The phased array 204 then operates as described above.

The present invention can also be used in wireless communication systems employing CDMA. To best explain the invention as it applies to CDMA wireless communication systems, it is useful to understand the operation of such systems. In CDMA systems, the term “channel” refers to a specific RF carrier frequency, bandwidth, and a unique code, which distinguishes the channel from other channels that use different codes. For a given frequency band, each mobile device is assigned a code that is orthogonal to the other codes used in the frequency band. In this manner, a base station can support a plurality of channels to communicate with the mobile devices within its service area (e.g., a sector).

In CDMA systems, it is desirable that all signals from mobile devices arrive at the base station with equal powers. If perfect power control is not maintained over each mobile device, then the detection deteriorates quite rapidly, thereby reducing the number of mobile devices in the cell and the capacity of the wireless communication system. CDMA systems are generally limited in capacity by interference. This is particularly true for the uplink (mobile to base station), where maintaining perfect power control for all mobile devices operating in a dynamic multipath environment is difficult. Since an increase in mobile output power is not desired (drains the battery), and increase in CDMA capacity must be achieved by increasing the antenna gain for particular mobile devices and/or reducing the gain of interfering sources.

FIG. 5 depicts a block diagram showing another embodiment of the present invention as used in a CDMA wireless communication system. The present invention comprises a smart antenna 502 coupled to a base station 112. As described above, the base station 112 is coupled to a BSC 512, which is in turn coupled to a MSC 514. The base station 112, BSC 512, and MSC 514 operate substantially as described above, with the exception that CDMA communication techniques are employed, rather than TDMA. Thus, each frequency band supports a plurality of orthogonal codes, which are assigned to particular mobile devices. The smart antenna 502 produces radiation patterns to transmit and.or receive traffic to and/or from the mobile devices over their respective channels.

In the present embodiment, the smart antenna 502 comprises a phased array 504 and a location sensing unit 506. Operation of the phased array 504 is described above with respect to FIG. 3. The phased array 504 is capable of dynamically modifying its radiation pattern in order to reduce the signal power level from interferers and to boost the signal power level from mobile devices with low received powers at the base station. For example, placement of a beam peak in the direction of a mobile device experiencing a temporary fade will ensure the receipt of equal power levels at the base station 112. Similarly, placement of a null in the direction of an interferer will reduce the noise power level at the base station 112.

The location sensing unit 506 can be configured as shown in FIG. 4. The location sensing unit 506 determines angle-of-arrival information and the received signal strength from the mobile devices. As described above, the antennas 208₁ through 208ₘ receive spatially diverse signals from the mobile devices communicating with the base station 112 (e.g., mobile device 406). The receivers 402₁ through 402ₘ receive the spatially diverse signals from the mobile devices. The received signals are digitized by the A/D converters 404₁ through 404ₘ and are coupled to the processor 408.

The processor 408 uses the particular identifying attribute of each mobile device to determine the location thereof. In the present embodiment, the location of a mobile device is the direction of the strongest transmitted signal. In CDMA systems, the particular identifying attribute is an orthogonal code. More specifically, the processor 408 decodes the signals using the orthogonal codes assigned to each of the mobile devices currently communicating with the base station 112 (i.e., mobile devices within the sector) in a known manner using code searching and correlation techniques. The orthogonal codes assigned to each of the mobile devices that are currently communicating with the base station 112 are received from the MSC 514 of the wireless communication system. Alternatively, the location sensing unit 206 can store the orthogonal codes in the memory 409.

Once the received signals from the mobile devices have been decoded, the processor 408 can store the code searching and correlation results in the memory 409. The processor 409 then only has to decode the signals from new mobile devices that initiate communication with the base station 112 for the first time. In this manner, the location sensing unit 506 can differentiate among the various mobile devices transmitting signals using the same frequency but different orthogonal codes. Using the decoded signals, the processor 408 can then determine the angles-of-arrival and the received signal strengths as described above for determining the direction of the strongest transmitted signal.

In the present embodiment, the location sensing unit 506 also determines the direction of interfering out-of-cell or out-of-sector mobile devices. As described above, CDMA systems use power control to receive signals from all mobile devices with the same power level at the base station. While CDMA systems provide power control for all mobile devices within the sector of a base station, the relative power levels between sectors or other cells will vary. Thus, out-of-cell or out-of-sector mobile devices can cause interference with the mobile devices communicating with the base station 112. The location sensing unit 506 can differentiate between the mobile devices within the service area of the base station 112 and out-of-cell or out-of-sector mobile devices by using the orthogonal codes received from the MSC 514. For example, in IS-95 wireless communication systems, the short sequence offset can be used to differentiate among the mobile devices within the service area from the mobile devices outside the service area. The MSC 514 can be used to indicate which orthogonal codes are assigned to the mobile devices within the service area of the base station 112 (e.g., a sector), and which are assigned to the mobile devices outside of the service area. Alternatively, the location sensing unit 206 can store this information in the memory 409.

The phased array 504 receives the direction of the strongest transmitted signal for each of the mobile devices from the location sensing unit 506. The phased array 504 also receives the direction the interfering out-of-cell or out-of-sector mobile devices. Alternatively, the phased array 504 can receive the physical locations of the mobile devices from the wireless communication system as described above via dashed path 516. In addition, the phased array 504 can received the received signal strengths using received signal strength indicator (RSSI) information from the base station 112.

In any case, if the received signal from a mobile device within the sector of the base station 112 has a less than desired power level, the phased array 504 modifies its radiation pattern to place a beam peak 508 in the direction of the mobile device (or the strongest received signal from the mobile device). A beam peak increases the gain, and thus maintains power control at the base station. If there is an out-of-cell or out-of-sector interferer, the phased array 504 modifies its radiation pattern to place a attenuation 510 in the direction of the interferer to reduce the gain, and thus reduce the noise at the base station.

When the phased array 504 forms an attenuation in the radiation pattern to reduce noise from interferers, the signal strength of mobile devices communicating with the base station 112 that happen to be in the same direction of the null will also be affected. In this instance, the present invention causes the base station 112 to instruct the affected mobile devices to increase signal power. By increasing signal power, the received signal strength from these affected mobile devices will remain constant as required in CDMA wireless communication systems.

The phased array 504 is capable of forming a plurality of transmit and receive beams for the frequency bands used by a particular cell or sector. In addition, the phased array 504 is capable of forming a broad beam for broadcast signals. Alternatively, the smart antenna 502 can comprise a supplementary antenna 507 (e.g., an omni-directional antenna) for producing the broadcast beam. In this manner, the smart antenna 502 of the present invention couples directly to the base station 112 and requires no changes to the architecture of the base station 112. This allows the present invention to be used with existing base stations in current CDMA wireless communication systems without substantial modification thereto.

While the foregoing is directed to the preferred embodiment of the present invention, other and further embodiments of the invention may be devised without departing from the basic scope thereof, and the scope thereof is determined by the claims that follow.

1. An apparatus for enhancing the capacity of a wireless communication system having a base station in communication with a plurality of mobile devices over a respective plurality of channels, each of the plurality of channels being defined in a frequency band by a particular identifying attribute, the apparatus comprising:
an antenna array for forming a beam in a radiation pattern; and
control circuitry for switching the direction of the beam towards a location of each mobile device when each mobile device is communicating over a respective channel.

2. The apparatus of claim 1, further comprising:
a location sensing unit for determining the location of each mobile device by determining the direction from which a strongest transmitted signal from each mobile device is received.

3. The apparatus of claim 2, wherein the location sensing unit comprises:
a plurality of spatially separated antenna elements; and
a processor for determining the angle-of-arrival for the strongest transmitted signal from each mobile device.

4. The apparatus of claim 3, wherein the location sensing unit is further configured to determine the location of each mobile device based on the particular identifying attribute.

5. The apparatus of claim 3, wherein the plurality of spatially separated antenna elements are part of the antenna array.

6. The apparatus of claim 1, wherein the location of each mobile device is determined from a physical location of each mobile device received from the wireless communication system.

7. The apparatus of claim 1, wherein the antenna array is capable of forming a broad beam for broadcasting signals to the mobile devices.

8. The apparatus of claim 1, further comprising:
a supplemental antenna for forming a broad beam to broadcast signals to the mobile devices.

9. The apparatus of claim 1, wherein the antenna array is coupled to a radio unit in the base station.

10. The apparatus of claim 1, wherein the particular identifying attribute is a time slot.

11. The apparatus of claim 1, wherein the particular identifying attribute is an identifyiny code.

11. The apparatus of claim 10, wherein the control circuitry is further configured to form an attenuation in the radiation pattern in the direction of an interferer when the interferer interferes with one or more of the plurality of mobile devices.

12. The apparatus of claim 11, wherein the interferer is an out-of-cell or out-of-sector interfering mobile device.

13. The apparatus of claim 12, wherein the base station causes particular ones of the plurality of mobile devices in the direction of the attenuation to increase transmission power.

14. The apparatus of claim 13, wherein the control circuitry is further configured to switch the direction of the beam towards the location of each mobile device as each mobile device is communicating over a respective channel when the received signal strength from each mobile device decreases.

15. A method of enhancing the capacity of a wireless communication system having a base station in communication with a plurality of mobile devices over a respective plurality of channels, each of the plurality of channels being defined in a frequency band by a particular identifying attribute, the method comprising:
forming a beam in a radiation pattern; and
switching the direction of the beam towards a location of each mobile device when each mobile device is communicating over a respective channel.

16. The method of claim 15, further comprising:
determining the location of each mobile device by determining the direction from which a strongest transmitted signal from each mobile device is received.

17. The method of claim 15, further comprising:
determining the location of each mobile device based on the particular identifying attribute.

18. The method of claim 15, further comprising:
determining the location of each mobile device by receiving the physical location of each mobile device from the wireless communication system.

19. The method of claim 15, further comprising:
forming a broad beam for broadcasting signals to the mobile devices.

20. The method of claim 15, wherein the particular identifying attribute is a time slot.

21. The method of claim 15, wherein the particular identifying attribute is an identifying code.

22. The method of claim 21, further comprising:
forming an attenuation in the radiation pattern in the direction of an interferer when the interferer interferes with one or more of the plurality of mobile devices.

23. The method of claim 22, wherein the interferer is an out-of-cell or out-of-sector interfering mobile device.

24. The method of claim 23, further comprising:
causing particular ones of the plurality of mobile devices in the direction of the attenuation to increase transmission power.

25. The method of claim 24, wherein the step of switching further comprises:
forming a beam in the radiation pattern in the direction of the strongest transmitted signal from each mobile device when the received signal strength from each mobile device decreases.
